(19) United States
(12) Patent Application Publication
(10) Pub. No.: US 2026/0194924 A1
(43) Pub. Date: Jul. 9, 2026

(54) REAL-TIME SMART ON-BOARD BASED FAULT DETECTION SYSTEM FOR UAVS

(71) Applicant: SAUDI ARABIAN OIL COMPANY, Dhahran (SA)

(72) Inventors: Ali J. Alrasheed, Thuwal (SA); Ibrahim S. Alsalamah, Thuwal (SA); Fadl Abdellatif, Thuwal (SA)

(73) Assignee: SAUDI ARABIAN OIL COMPANY, Dhahran (SA)

(21) Appl. No.: 19/009,061

(22) Filed: Jan. 3, 2025

(51) Int. Cl. G05D 1/86; B64D 45/00; G05D 101/15; G05D 109/25; G05D 111/20; G05D 111/50; G05D 111/60

(52) U.S. Cl. CPC G05D 1/86; B64D 2045/0085; G05D 2101/15; G05D 2109/254; G05D 2111/20; G05D 2111/50; G05D 2111/60

(57) ABSTRACT

Fault detection systems for an unmanned aerial vehicle (UAV) are disclosed. A representative system includes a UAV on-board microcontroller with a processor and memory communicatively connected to the UAV. The microcontroller is configured to run one or more machine learning models and to alter operating parameters of the UAV. Such a system further includes a plurality of microphones mounted on a UAV. The microphones are configured to capture acoustic signals characteristic of UAV operation conditions. An array of vibration sensors is embedded within the UAV. The vibration sensors are configured to detect vibration patterns and store them as readable data in the memory. The processor further analyzes the vibration patterns for abnormalities relative to parameters stored in the memory indicative of a first fault detection and responds by altering operating parameters. Additionally, methods for real-time fault detection in a UAV are disclosed.

### FIELD OF THE DISCLOSURE

The present disclosure relates generally to the field of unmanned aerial vehicles (UAVs) and monitoring systems, and more specifically to an integrated on-board fault detection system for UAVs incorporating multi-modal sensors and analytic algorithms for real-time health monitoring, with capabilities for early detection and response to operational anomalies to prevent failures during missions.

### BACKGROUND OF THE DISCLOSURE

As unmanned aerial vehicles (UAVs, or “drones”) take on more tasks across industries and environments, the need for reliable on-board fault detection systems has become increasingly evident. Traditional fault detection in UAVs often relies on post-flight data analysis or manual monitoring during operation, and these methods may fail to provide the immediacy required to preclude failure. Moreover, when UAVs are deployed in hazardous or remote areas, these conventional approaches are insufficient for the timely identification of faults, which could lead to costly and potentially dangerous repercussions. Despite advancements in sensor technologies and on-board analytics, existing solutions have yet to offer a comprehensive, automated, and real-time monitoring system integrated into the UAV's architecture.

Existing fault detection systems for UAVs tend to focus on singular data points or isolated aspects of UAV health, lacking a unified platform that synthesizes data streams for a more accurate diagnosis. Preexisting systems can be hampered by computational limitations, environmental interference, and delayed response times. Furthermore, the incremental weight and power demands of such systems often present trade-offs between UAV performance and safety assurance. Acoustic-based diagnostics, while promising in their sensitivity, remain challenged by background noise and the need for sophisticated signal processing capable of real-time operation within the constraints of UAV hardware.

Finally, most previous fault detection methodologies necessitate a compromise between detection sensitivity and operational efficiency, as the sensor arrays and computational modules required for in-depth monitoring can impinge upon the UAV's payload capacity and flight time. Real-time transmission and processing of the data for rapid decision-making is yet another hurdle not adequately addressed by prior systems. As UAV applications continue to broaden to include situations with minimal margin for error, such as delivery of medical supplies or inspection of critical infrastructure, the absence of an efficient, integrated, on-board fault detection system represents a significant barrier to the adoption and scalability of UAV technology in these high-stakes fields.

The present disclosure is directed to mitigate and resolve these concerns.

### SUMMARY OF THE DISCLOSURE

In one or more embodiments, a fault detection system for an unmanned aerial vehicle (UAV) comprises a UAV on-board microcontroller. The microcontroller has a processor with a memory. The processor is communicatively connected to the UAV. In some implementations, code is storable in the memory and executable in the processor. The microcontroller is configured to run one or more machine learning models defined by the code. The microcontroller is configured to alter operating parameters of the UAV. The system further comprises a plurality of microphones mounted on a UAV. The microphones are configured to capture acoustic signals characteristic of UAV operation conditions. An array of vibration sensors is embedded within the UAV. The vibration sensors are configured to detect vibration patterns and store them as readable data in the memory. The code further configures the processor to analyze the vibration patterns for abnormalities relative to parameters stored in the memory indicative of a first fault detection.

In one or more variations, pressure sensors are integrated into the structure of the UAV and are configured to monitor for UAV structural stress and deformation indicative of a second fault detection. One or more thermal cameras are also mounted on the UAV. The thermal cameras are configured to capture images indicating overheating and structural abnormalities indicative of a third fault detection. A control and communication module within the microcontroller is communicatively connected to receive signals from the plurality of microphones, the array of vibration sensors, the integrated pressure sensors, and the one or more thermal cameras. The control and communication module is configured to store state information responsive to the indication of the first, second, or third fault detections, if any, and is further configured to respond to the indication of any fault detections by altering operating parameters of the UAV to reduce or eliminate the indication of the detected fault.

In more particular arrangements, the control and communication module is further configured to provide real-time alerts in response to indications of the first, second, or third fault detections, if any, through analysis of one or more of the received signals. In one or more variations, the microphones are configured to detect a range of acoustic anomalies comprising motor noises and mechanical defects; the vibration sensors are accelerometers; the UAV further comprises a fuselage supporting propellers and landing gear; and the pressure sensors are thin-film pressure sensors configured to detect plastic deformation and are mounted in the vicinity of the propellers, the landing gear, or both.

In some implementations, each thermal camera is configured to conduct continuous imaging of one or more UAV components; the microcontroller utilizes one or more TinyML algorithms; the control and communication module is integrated within a flight control system of the UAV; and the control and communication module is configured to send mission abort signals to the flight control system upon detection of a fault. In additional arrangements, the system further comprises one or more fast shutter speed cameras with a shutter speed falling in the range of about 1/250th of a second up to about 1/8000th of a second; data collected by the vibration sensors is analyzed by deep learning models run in the microcontroller and utilizing time-series analysis in order to identify gradual deformation; and the control and communication module further comprises a user interface to provide one or more of visual and auditory alerts to the UAV operator upon fault detection.

Additionally, in one or more embodiments, a method for real-time fault detection in an unmanned aerial vehicle (UAV) is provided. The UAV has a structure that comprises a fuselage, propellers, and landing gear. The method comprises capturing acoustic signals. These signals are captured with a plurality of microphones that are mounted on-board the UAV. Vibration abnormalities are detected. This is done with embedded vibration sensors mounted on-board the UAV. The method further involves monitoring stress of the UAV structure with on-board thin-film pressure sensors. UAV components are also imaged with thermal cameras mounted on-board the UAV. Captured signals and collected data are processed through a microcontroller that is on-board and communicatively connected to the microphones, vibration sensors, pressure sensors, and thermal cameras. In some implementations, the microcontroller comprises a processor that has a memory and code and is configured to run machine learning algorithms. These algorithms are defined by the code. The code configures the processor of the microcontroller to detect anomalies that are indicative of potential UAV faults.

The details of one or more implementations are set forth in the accompanying drawings and the description below. Other features will be apparent from the description, from the drawings, and from the claims.

### BRIEF DESCRIPTION OF THE DRAWINGS

The foregoing and other objects and advantages of the present disclosure will become more apparent when considered in connection with the following detailed description and appended drawings in which like designations denote like elements in the various views, in which:

FIG. 1 is an unmanned aerial vehicle equipped with sensors and components for use in one or more embodiments of systems and methods for on-board UAV fault detection consistent with the present disclosure.

FIG. 2 is a set of UAV propellers integrated into one or more systems consistent with the present disclosure and undergoing lift forces during flight.

FIG. 3 is a set of broken UAV propellers after undergoing destructive plastic deformation from lift forces during flight.

FIG. 4 is a thin-film pressure sensor for use in one or more systems and methods for on-board UAV fault detection consistent with the present disclosure.

FIG. 5 is a finite element analysis of a UAV frame, showing bending of structural components of the UAV.

FIG. 6 is a set of thermal and fast shutter speed cameras deployed on-board a UAV and consistent with one or more implementations of the systems and methods disclosed herein.

### DETAILED DESCRIPTION OF CERTAIN EMBODIMENTS CONSISTENT WITH THE DISCLOSURE

The present disclosure relates to a real-time fault detection system for unmanned aerial vehicles (UAVs, or “drones”), addressing limitations of prior solutions by integrating multiple sensors and machine or deep learning algorithms. Traditional methods often rely on single-sensor data or limited fault detection techniques, such as using only vibration sensors to predict functional anomalies in UAVs without considering other potential fault indicators like sound and thermal variations. Moreover, previous approaches generally focus on specific UAV components, thereby lacking a comprehensive evaluation of the entire UAV's health. The present disclosure uniquely combines sound, vibration, thermal, and pressure sensors, offering a more holistic and accurate fault detection system.

The core of this system lies in its ability to utilize a variety of sensors and machine learning models to monitor and analyze UAV health in real-time. Sound sensors, such as high-sensitivity microphones, capture ambient and mechanical sounds, in some cases detecting anomalies through TinyML models running on edge devices. Vibration sensors, particularly high-sensitivity accelerometers, are strategically placed on UAV components to identify abnormal vibration patterns indicative of potential faults. Thin-film pressure sensors embedded within the UAV's structure monitor stress and deformation, especially in high-risk areas like the propellers, the fuselage, and landing gear. Additionally, on-board thermal cameras mounted on poles provide continuous thermal imaging to detect overheating and structural abnormalities.

Systems consistent with the present disclosure also in some instances feature a control and communication module that integrates with a UAV's flight control system, facilitating real-time alerts and automatic mission aborts upon detecting critical anomalies. This module processes data from all sensors, employing machine learning algorithms such as convolutional neural networks (CNNs) and recurrent neural networks (RNNs) to classify and analyze the collected data. By combining data from multiple sensors and cross-validating the results, the system significantly reduces false positives and improves fault detection accuracy. This comprehensive approach ensures enhanced safety, reliability, and efficiency of UAV operations, particularly in hazardous or high-stakes environments such as oil and gas fields. The expected commercial applications for systems and methods consistent with the present disclosure encompass a range of sectors, including hazardous area UAVs, delivery UAVs, industrial inspections, agriculture UAVs, surveillance and security, as well as photography and filmmaking.

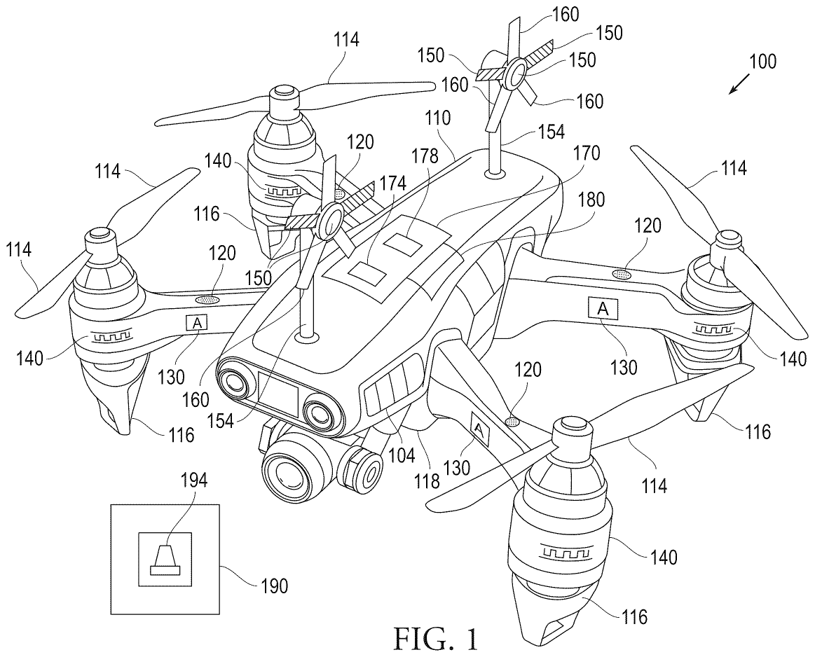

FIG. 1 is a diagram 100 of an unmanned aerial vehicle 110 equipped with sensors and components for use in one or more embodiments of systems and methods for on-board UAV fault detection consistent with the present disclosure. In one or more embodiments, the fault detection system for a UAV 110 consistent with the present disclosure comprises a UAV on-board microcontroller 170 (also sometimes referred to as a “microcontroller unit 170” or “MCU 170”) having a processor 174 with a memory 178. In some variations, the processor 174 is communicatively connected to the UAV 110. In some implementations, code is storable in the memory 178 and executable in the processor 174. In some variations, the microcontroller 170 is configured to run one or more machine learning models defined by the code. In one or more implementations, the UAV 110 further comprises an on-board flight control system 104, a fuselage 118 with landing gear 116, and one or more motors.

In some implementations, a plurality of microphones 120 are mounted on the UAV 110. The microphones 120 are configured to capture acoustic signals characteristic of UAV 110 operation conditions. Experienced UAV operators often identify mechanical problems by listening for unusual sounds. In one or more variants, these anomalies—detectable by systems consistent with the present disclosure—can include abnormal motor noise, broken propeller 114 tips, loose or missing screws, chassis cracks, and other mechanical defects that may not be immediately visible but can be detected audibly. Relying solely on human experience is not feasible for continuous monitoring and rapid response. In multiple variations, one or more embodiments of the present disclosure implement an automated or semi-automated system that can detect these anomalies in real-time using sound sensors (i.e., microphones 120) and TinyML (Tiny Machine Learning) on edge devices embedded in a UAV, such as UAV 110. An edge device is any piece of hardware that controls data flow at the boundary between two networks, two hardware devices, or a combination of hardware devices and software. Edge devices, such as the microphones 120 on a UAV 110, fulfill a variety of roles, depending on what type of device they are, but they essentially serve as network endpoints—entry or exit points. Some common functions of edge devices include the transmission, routing, processing, monitoring, filtering, translation and storage of data passing between networks.

In some implementations, the present disclosure involves a real-time anomaly detection system for UAVs 110 that operates on the edge using TinyML (or other machine learning and software algorithms) and sound sensors, such as the microphones 120. In further configurations, the system is designed to detect abnormalities such as changes in motor noise, loose or missing screws, and other mechanical issues by analyzing sound patterns collected by the microphones 120 during UAV 110 flight. In some variations, the components and architecture of systems consistent with the present disclosure involve sound sensors such as high-sensitivity microphones 120 placed strategically on the UAV 110 to capture ambient and mechanical sounds. In multiple variations, a microcontroller unit (“MCU”) 170 or other on-board computer such as the ARM Cortex-M series, Jetson Nano, or Raspberry PI is used to perform the storage and analysis functions. In some implementations, a TinyML model ran on the microcontroller 170 is a pre-trained machine learning model designed to identify anomalous sound patterns. In one or more variants, an alert system 194 is used to notify the operator in real-time if an anomaly is detected, which could be visual, auditory, or a combination of notifications. In some cases, these alerts are provided on a user interface 190.

In some implementations, data collection and pre-processing related to the on-board UAV fault detection methods consistent with the present disclosure involve multiple sound sensors (such as microphones 120) capturing audio data during the UAV 110's flight. In one or more variants, the raw sound data is pre-processed via microcontroller 170 to remove noise and irrelevant signals, involving filtering, normalization, and converting audio signals into a suitable format for analysis, such as Mel-frequency cepstral coefficients (MFCCs) and spectral roll-off. In further configurations, TinyML model training includes creating a comprehensive dataset of normal and anomalous sound patterns. This includes sounds from healthy UAVs and those with known mechanical issues. In multiple variations, the model is developed using a machine learning framework compatible with TinyML, such as TensorFlow Lite for microcontrollers, to classify sound patterns and train a neural network model for the accomplishing same. In some variations, the trained model is optimized for deployment on the microcontroller 170, focusing on reducing memory and computational requirements while maintaining accuracy.

In some implementations, real-time anomaly detection involves deploying the optimized TinyML model on the UAV 110's MCU 170. In one or more variants, the MCU 170 continuously processes incoming sound data during the UAV's flight, extracts features of the sound data, and inputs them into the TinyML model. In multiple variations, the model classifies sound patterns in real-time, and if an anomaly is detected, the system triggers the alert mechanism 194. In further configurations, the alert system 194 sends real-time notifications to a UAV operator upon detecting an anomaly. In some implementations, this can be achieved through visual indicators on a UAV 110's control interface—potentially a part of the UAV 110's flight control system 104—or via auditory alarms. In some variations, the system's microphones 120 are configured to detect a range of acoustic anomalies comprising motor noises and mechanical defects.

Selecting a TinyML architecture model for use in the UAV 110's MCU 170 requires assessing specific requirements of the application, such as accuracy, latency, and computational resources. In one or more variants, the architecture of the TinyML model is designed to be lightweight and efficient, suitable for deployment on resource-constrained MCUs 170. In multiple variations, Convolutional Neural Networks (CNNs) are suited for analyzing structured data like images and spectrograms derived from audio signals sent from the microphones 120, though other models can be selected or combined. In further configurations, components of the CNN utilized in the UAV 110's on-board MCU 170 include an input layer for pre-processed sound features, convolutional layers with small filter sizes (such as, but not limited to, VGG16 and mobileNet), and dense layers for final classification. Dense layers are fully connected layers to perform the final classification of a sound anomaly sent to an MCU 170 on-board a UAV 110. The output layer uses an activation function suitable for the classification task (e.g., softmax for multi-class, sigmoid for binary). The multi-class could be used for specific fault detections, and the sigmoid for general faults (faults or no faults).

In some variations, Recurrent Neural Networks (RNNs) are suitable for sequence data such as the type sent from microphones 120 and stored in the MCU 170 and can capture temporal dependencies. RNNs are particularly useful when analyzing time-series data such as audio signals. In multiple variations, components include an input layer for sequential audio features, recurrent layers like Layers like Long Short-Term Memory (LSTM) or Gated Recurrent Unit (GRU), and dense layers for classification. The input layer accepts sequential audio features. The recurrent layers process the temporal data. The dense layers are fully connected layers for classification and contain an appropriate activation function (to enable further instruction based on a detected anomaly) for the output layer.

In one or more variants, hybrid models combine CNNs and RNNs to leverage both spatial and temporal features while analyzing signals received by the MCU 170. The components of the hybrid model system for use in the UAV 110 MCU 170 for classifying anomalies include an input layer that accepts pre-processed audio features. Following this, convolutional layers are employed to extract spatial features. Recurrent layers are then utilized to capture temporal dependencies from the CNN output. Finally, dense layers perform the final classification. In further configurations, TinyML-specific models like TensorFlow Lite Micro models are utilized for data processing in the UAV 110's MCU 170 because they are optimized for performance on MCUs. In some implementations, systems consistent with the present disclosure include simplified versions of the above architectures with fewer parameters and lower computational requirements. In some implementations, model optimization techniques like quantization and pruning are employed for deployment on resource-constrained MCUs 170 in a UAV 110.

TinyML models employed in the MCU 170, as consistent with one or more embodiments of the present disclosure, require, in some instances, training a supervised learning model to identify deviations from normal sound patterns and classify different mechanical issues based on their unique sound signatures (e.g. frequency created). To collect the data for training these models, audio data is recorded from UAVs during regular operation to capture normal operation sounds. Additionally, audio data is recorded representing different mechanical issues, such as loose screws, motor defects, and propeller damage. For example, sounds of screws rattling or vibrating can indicate loose screws, while irregular noises can signify motor defects. Damaged or imbalanced propellers produce distinctive sounds that are also recorded for use in the TinyML model training data. Once the data is collected, it must be manually labeled, in some implementations, with corresponding categories like “Normal,” “Loose Screw,” “Motor Defect,” and “Propeller Damage.” This labeled data serves as the foundation for training the machine learning model or models configured to be run on the UAV's on-board MCU 170. Where anomaly training data is limited, a “normal operation” dataset is utilized, and anomaly detection will involve flagging sensor readings that are far from the “normal” operations for further analysis and possible alert generation. In one or more variants, methods consistent with the present disclosure further comprises training the machine learning algorithms on a dataset containing labeled examples of both normal and abnormal operational conditions for various UAV models.

In some implementations, after training data is collected and compared to in-flight sensor data collection, the next step is feature extraction from the audio data to capture the characteristics of the sounds. In some implementations of machine learning model deployment, significant sound features include but are not limited to Mel-Frequency Cepstral Coefficients (MFCCs), which capture the power spectrum of the sound; spectral centroid, indicating the center of mass of the spectrum; zero-crossing rate, measuring the rate at which the signal changes sign; and spectral bandwidth, measuring the width of the spectrum. Averages of features derived by employing sound capture techniques such as this are used to further train and refine neural network models deployed in a UAV's on-board MCU 170. In some variations, full time-series features are used to train a RNN (e.g., LSTM). Spectrograms or other graph-based features are also used to train a CNN network deployed in a UAV's on-board MCU 170, consistent with one or more systems disclosed herein. Additional systems consistent with the present disclosure employ anomaly detection techniques such as autoencoders and one-class SVM (Support Vector Machine) models. An autoencoder is trained to learn the normal sound patterns of the UAV, and anomalies are detected by comparing normal sound patters against any reconstruction error; a high error indicates an anomaly. A one-class SVM model can also distinguish between normal operation sounds and anomalies. In one or more variants, the step of capturing acoustic signals further comprises the step of differentiating between different types of audio frequency characteristics of various mechanical defects.

In some variations, an array of vibration sensors 130 are embedded on or within the UAV 110. In some implementations, the vibration sensors 130 are configured to detect vibration patterns and store them as readable data in the memory 178. In some implementations, the code further configures the processor 174 to analyze the vibration patterns for abnormalities relative to parameters stored in the memory 178. In some implementations, systems consistent with the present disclosure incorporate vibration sensors 130 strategically placed on various parts of a UAV 110 to detect abnormal vibration patterns that are indicative of potential faults. In some implementations, the system's vibration sensors 130 are accelerometers. By continuously monitoring in-flight vibrations, systems consistent with the present disclosure identify malfunctions in real-time and initiate failsafe protocols or a mission abort to prevent damage or failure. In some implementations, the control and communication module 180 is integrated within a flight control system 104 of the UAV 110. In some variations, the control and communication module 180 further comprises a user interface 190 to provide one or more of visual and auditory alerts to the UAV operator upon fault detection.

In multiple variations, systems consistent with the present disclosure comprise high-sensitivity accelerometers 130 capable of detecting minute vibrations. In further configurations, these vibration sensors 130 are strategically positioned on critical UAV 110 components such as the chassis (i.e., fuselage) 118, motors, propellers 114, and other vital areas. In most implementations, the system includes an on-board MCU or other computer equipped with a processor 174 or processors 174 to analyze vibration data in real-time. In some variations, the MCU 170 is integrated with the UAV 110's flight control system 104 to send alerts or commands. In one or more variants, anomaly detection algorithms (including utilization of CNNs, RNNs, or hybrids comprising both, such as with the microphones 120) are implemented using pre-trained machine learning models trained on vibration data to recognize normal and abnormal patterns.

In multiple variations, the system also utilizes signal processing techniques processed in the UAV 110's MCU 170 to analyze vibration or other sensor data. In multiple implementations, signal processing techniques are utilized to analyse sensor data to detect faults in UAVs, such as UAV 110. In some implementations, and as an example of one such signal processing technique, a Fast Fourier Transform (or FFT) is employed. A Fast Fourier Transform (FFT) is an algorithm that computes the Discrete Fourier Transform (DFT) of a sequence, or its inverse (IDFT). In the context of the present disclosure, an FFT converts a time-domain vibration signal into the frequency domain, which aids in identifying abnormal frequencies that may occur due to UAV faults. In some implementations, and as a second example of an applicable signal processing technique in the context of the present disclosure, a “wavelet transform” is employed: wavelet transforms are mathematical tools for analyzing data where features vary over different scales. For signals, features of wavelet transforms include but are not limited to frequencies varying over time, transients, or slowly varying trends. With respect to some implementations of the present disclosure, wavelet transforms are utilized to capture both time-varying and frequency-varying information, including the capture of short and sudden events or changes due to faults in the UAV 110.

In some implementations, simpler signal processing techniques may be employed such as computation of time-varying root mean square (RMS) trends. Further implementations employ quantization and analysis of power fluctuation trends, both of which sometimes indicate higher vibration than usual in a UAV 110. An additional signal processing technique used in some variations for analyzing vibration or other sensor data incorporates autoregressive models to predict the future behaviour of a UAV 110 component based on past values to allow for early detection of these anomalies.

In further configurations, a control and communication module 180 includes an alert system that sends real-time alerts to the UAV 110's flight control system 104 and operators, via, for example, a user interface 190 that can generate alerts 194. In some implementations, the mission abort mechanism automatically initiates a safe landing or returns the UAV to a designated safe location upon detecting critical anomalies. In some implementations, methods consistent with the present disclosure further comprise processing signals in the MCU 170 from the vibration sensors 130. In some implementations, data collected by the vibration sensors 130 is analyzed by deep learning models run in the microcontroller 170 and utilizing time-series analysis in order to identify gradual deformation.

In some variations, pressure sensors 140 are integrated into the structure of the UAV 110. In some implementations, the pressure sensors 140 are configured to monitor for UAV 110 structural stress and deformation. Thin-film pressure sensors are available in many shapes and sizes. At present, most are used in the development of prosthetics. A surprising benefit of the present disclosure is the strategic embedding of thin-film pressure sensors 140 into the structure of the UAV 110 where most structural failures occur. For example, the propeller 114 of a UAV 110 usually undergoes considerable bending forces due to centrifugal force and due to lifting forces, which sometimes leads to hazardous outcomes such as propellers 114 detaching from the base of a UAV 110 and projecting outward. In multiple implementations, employment of UAV 110 structure-embedded thin film pressure sensors 140 are utilized to detect early sings of plastic deformation in critical UAV components such as propellers 114 and landing gear 116. In one or more variants, the step of monitoring structural stress further comprises real-time analysis of stress distribution and detection of plastic deformation in the structure of the UAV 110.

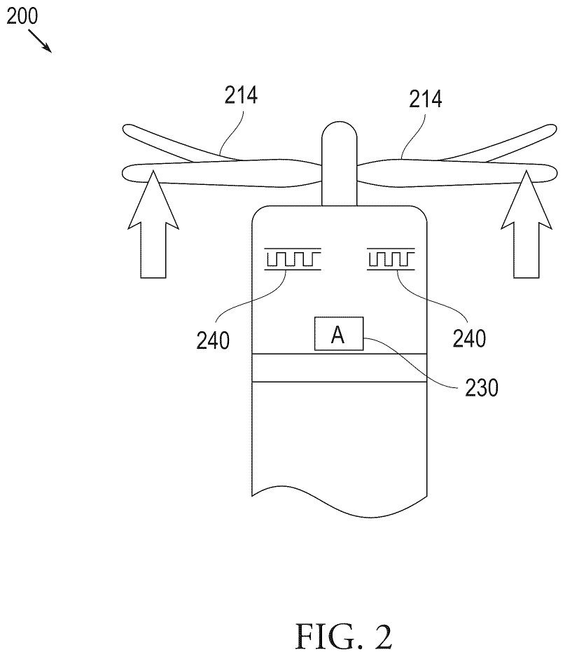

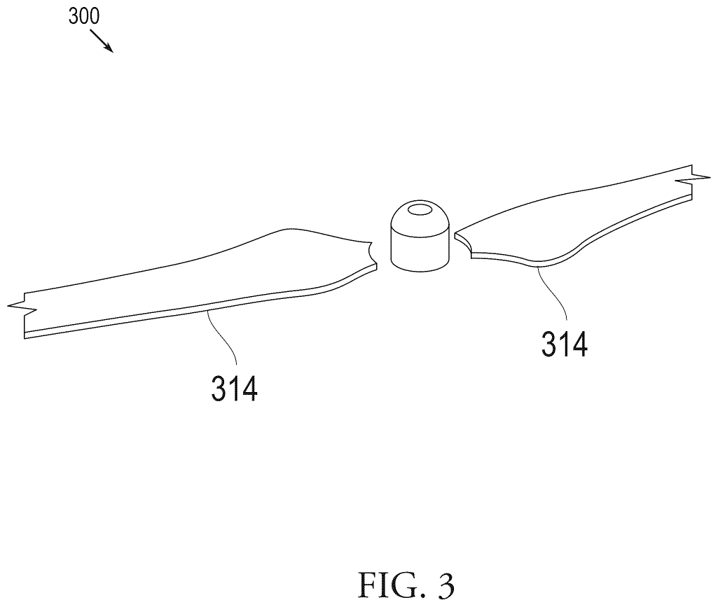

FIG. 2 is a set 200 of UAV propellers 214 integrated into one or more systems consistent with the present disclosure containing thin-film pressure sensors 240 and vibration sensors 230 while undergoing lift forces (arrows in FIG. 2) during flight. FIG. 3 is a set 300 of broken UAV propellers 314 after undergoing destructive plastic deformation from lift forces during flight. The types of forces in FIG. 2 lead to plastic deformation in UAV parts such as the propellers 214 in FIG. 2 and the broken propellers 314 in FIG. 3, which can cause propellers 214 and 314 (or other components) to break. In one or more implementations, one or more vibration sensors 230 and pressure sensors 240 are embedded into multiple areas of the UAV (such as the multiple vibration sensors 130 and pressure sensors 140 depicted in in FIG. 1). These sensors enable detection of early signs of plastic deformation and failure before irreversible damage to UAV components occurs.

UAV landing gear is another common location for bending and part failure. During instances of emergency UAV landing, and especially in cases where the UAV is carrying a heavy payload, the chances of plastic deformation increase. In multiple implementations, inclusion of one or more vibration sensors 230 and pressure sensors 240 integrated with a UAV flight control system (such as flight control system 104 in FIG. 1) and the control and communication module (such as flight control system 180 in FIG. 1) facilitates real-time adjustments of landing speed based on a calculation of the amount of pressure being exerted on the UAV landing gear (such as landing gear 116 in FIG. 1) due to a payload weight increase.

In additional implementations, one or more vibration sensors 230 and pressure sensors 240 are integrated on a UAV's motor mounts and arms. Sometime UAVs experience dynamic loading where the speed of the propellers increase and decrease rapidly, which stresses the structure of the UAV. Incorporation of a means to monitor this in-flight stress allows for real-time adjustments that reduce this stress before it becomes irreversible and extends the lifetime of UAV structural components.

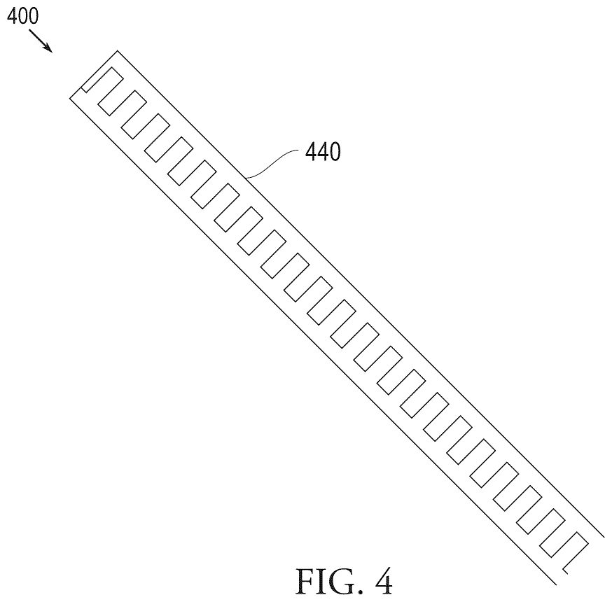

FIG. 4 is an example 400 of a thin-film pressure sensor 440 (comparable to the pressure sensors 140 in FIG. 1 and the pressure sensors 240 in FIG. 2) for use in one or more systems and methods for on-board UAV fault detection consistent with the present disclosure. Regarding determinations of pressure sensor 440 placement, on-board fault detection systems consistent with the present disclosure comprise strategic placement of thin-film pressure sensors 440 embedded in the UAV 110's structure. The UAV 110's architecture influences the dynamics of its movement and control, and so in multiple implementations of the system, each UAV design will have a different area where dynamic forces are transferred from a force-generating component. Generally, following the path of thrust-generating components informs structural areas that have the greatest need for pressure sensor 140 placement.

UAV motor mounting equipment undergoes at least two types of dynamic forces due to the rotation of the motors: torsional force and bending force on a rod or beam, if any, used to hold a UAV motor in place. Additionally, landing gear (such as landing gear 116 in FIG. 1) undergoes forces that could cause breakage and prevent a UAV 110 from landing safely. The forces a UAV experiences are subject to change whenever payload changes since the dynamics of the UAV change slightly, including the center of gravity, the center of pressure, the drag force, and other forces. Spikes in impact forces generated during, for example, landing are reduced where pressure sensor 140 data is properly collected and processed for proactive reduction of landing force, as consistent with some implementations of systems disclosed herein. Each of these mechanical locations on a UAV are appropriate for placement of thin-film pressure sensors 140. Therefore, in some variations, the UAV 110 further comprises a fuselage 118 supporting arms with propellers 114 and landing gear 116. In some variations, the pressure sensors 140 are thin-film pressure sensors configured to detect plastic deformation and are mounted in the vicinity of the propellers 114, the landing gear 116, or both the vicinity of the propellers 114 and the landing gear 116.

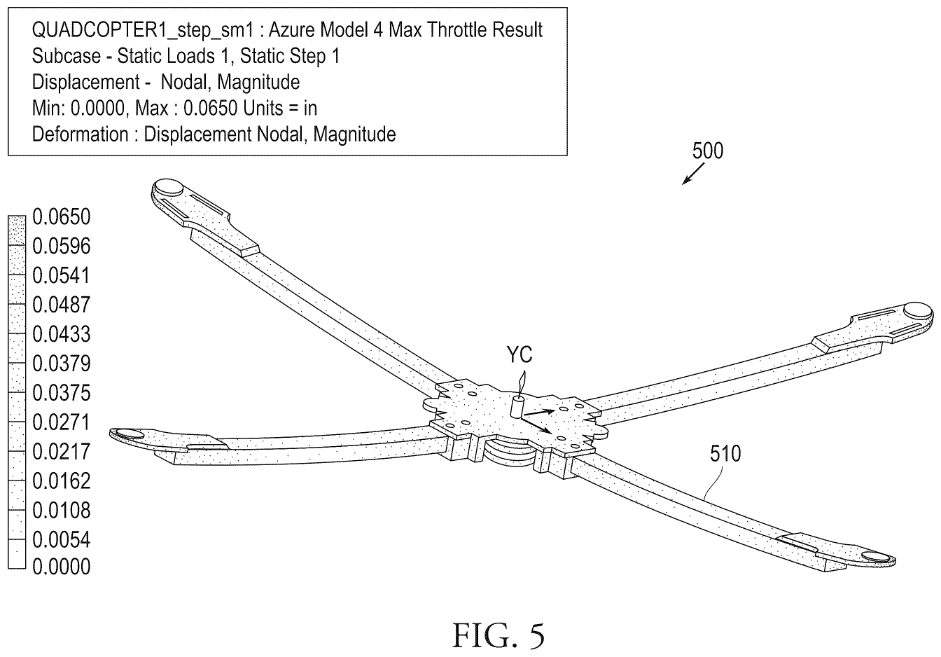

FIG. 5 is a finite element analysis 500 of a UAV frame, showing bending of structural components of the UAV. In some variations, finite element analysis is utilized to analyze the UAV frame 510, illustrating the bending of the structure. In one or more variants, possible anomaly detection algorithms using deformation sensors to generate and perform real-time in-flight finite element analysis include machine learning models. In multiple variations, Support Vector Machines (SVMs) are trained on normal UAV deformation pattern data sets to inform the detection of UAV component stress anomalies. In further configurations, ensemble methods such as Random Forest or Decision Tree are used to classify normal and abnormal deformation patterns. In some implementations, deep learning models are also employed. In some variations, neural networks (NN) are utilized with feature engineering to classify a deformation signal sent from pressure sensors (such as FIG. 1's pressure sensors 140 and FIG. 2's pressure sensors 240) to the microcontroller 170. In one or more variants, Convolutional Neural Networks (CNNs) are used to classify deformation signals, extracting features directly from raw data received from microcontroller 170 and transmitted by the pressure sensors 140. In multiple variations, Recurrent Neural Networks (RNNs) such as LSTM or gated recurrent unit (GRU) networks (a special type of RNN network that aims to solve the vanishing gradient problem which comes with a standard recurrent neural network) capture temporal dependencies in deformation data, identifying anomalies over time.

In further configurations, anomaly detection algorithms include the use of autoencoders for identifying and rectifying irregular stress on UAV components. In some implementations, autoencoders are trained to learn normal deformation patterns, with abnormal patterns resulting in reconstruction errors indicating potential faults. In some variations, Isolation Forests are used to identify anomalies by isolating them from the bulk of the data in a high-dimensional space. In one or more variants, time-series analysis is conducted using LSTM or RNN networks to analyze temporal sequences of deformation data for detecting gradual changes. In multiple variations, employing one or more of the machine learning techniques above in the microcontroller 170 presents a multidimensional system for detecting abnormal deformations in UAVs using strategically placed pressure sensors, enabling real-time fault detection and, where necessary, mission abort capabilities. In some implementations, anomaly detection algorithms and additional features like adaptive learning, multi-sensor integration, and predictive maintenance are incorporated to act on information received from both vibration sensors 130 and pressure sensors 140.

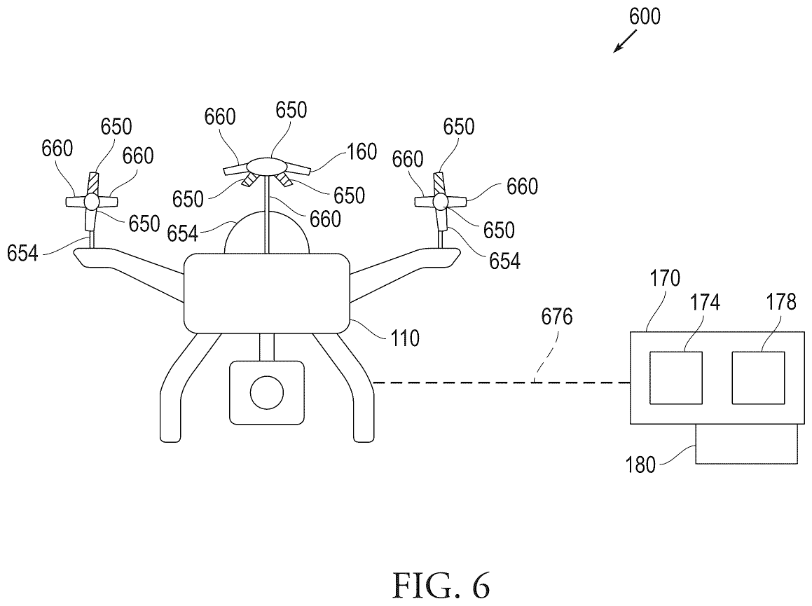

FIG. 6 is a set 600 of thermal cameras 650 and fast shutter speed cameras 660 deployed on-board a UAV 110 and consistent with one or more implementations of the systems and methods disclosed herein. In some implementations, one or more thermal cameras 650 (analogous to FIG. 1's thermal cameras 150) are mounted on the UAV 110. In some implementations, the thermal cameras 650 are configured to capture images indicating overheating and structural abnormalities. In some implementations, a thermal camera 650 can be mounted on a telescoping pole 654 (analogous to FIG. 1's telescoping pole 154) on the body of the UAV 110. One or more implementations also include high-resolution thermal cameras 650 with a 360-degree field of view. Briefly, and as discussed further below, the one or more fast shutter speed cameras 660 have a range of about 1/250th of a second up to about 1/8000th of a second, though most have a shutter speed of about 1/4000th of a second.

The thermal cameras 650 are connected to the UAV microcontroller 170 to transmit signals of continuous imaging of a UAV's arms, motors, and propellers, enabling generation of a UAV heatmap and detecting temperature anomalies that indicate potential faults. In further configurations, the thermal cameras 650 can be placed on the UAV with a pole 654 or similar structure and can be positioned at different angles to cover the structure of the UAV 110. Restated, in some implementations, each thermal camera 650 is configured to conduct continuous imaging of one or more UAV 110 components. In some implementations, the step of imaging includes generating one or more heatmaps and analyzing thermal patterns over time.

In some implementations, a microcontroller unit (MCU) 170 or other on-board computer is equipped with a processor or processors 174 to analyze thermal data captured by the thermal cameras 650 in real-time. In some variations, this unit 170 is connected via electronic connection 176 to the UAV's flight control system (such as flight control system 104 in FIG. 1) to send alerts or commands. In one or more variants, anomaly detection algorithms executed in the MCU 170 employ pre-trained models using AI to recognize normal and abnormal patterns in thermal data. In multiple variations, signal processing techniques are also utilized to analyze this data. In further configurations, the control and communication module 180 is in electronic communication with the MCU 170. The control and communication module 180 includes an alert system that sends real-time alerts to the UAV's flight control system 104 and operators. In some implementations, a mission abort mechanism automatically initiates a safe landing or returns the UAV 110 to a designated safe location upon detecting critical thermal anomalies.

In some variations, relatively lightweight mounting poles 654 compared to other UAV components are attached to the UAV 110's frame, strategically positioned to ensure minimal impact on the UAV's aerodynamics and payload capacity. In one or more variants, multiple small thermal cameras 650 are mounted on these poles 654, angled to provide clear views of the UAV's arms, motors, and propellers. In multiple variations, the thermal cameras 650 are arranged to ensure comprehensive thermal coverage of all critical UAV components, capturing detailed thermal data during flight. In further configurations, the thermal cameras 650 continuously monitor the motors for unusual heat patterns that indicate overheating, excessive friction, electrical issues, or other issues detectable by thermal cameras. In some implementations, sudden spikes or uneven heat distribution can signal potential motor failures, allowing for early intervention.

In some variations, the thermal cameras 650 send signals to the MCU 170 which checks for consistent temperature distribution across the propellers (such as propellers 114 in FIG. 1). In one or more variants, abnormal heat spots can indicate cracks, damage, or imbalances in the propellers 114, which could lead to mechanical failure. In multiple variations, the thermal cameras 650 monitor the UAV 110's body for hot spots that can indicate stress points or potential structural failures. In further configurations, consistent thermal monitoring helps in detecting issues like loose connections, battery overheating, or electronic component malfunctions. In some implementations, the thermal data is transmitted to the UAV 110's MCU 170 for data processing, where machine learning algorithms analyze the transmitted thermal data in conjunction with data from sound sensors 120, vibration sensors 130, and pressure sensors 140. In some variations, combining thermal data with other sensor data enhances the accuracy of fault detection, reducing false positives and improving reliability. Various implementations of the thermal cameras 650 incorporate one or more of the machine learning techniques to analyze thermal data is ways similar to those described previously with respect to the other sensors, such as the sound sensors 120, the vibration sensors 130, and the pressure sensors 140.

In some variations, the system further comprises one or more fast shutter speed cameras 660 (analogous to FIG. 1's fast shutter speed cameras 160) with a range of about 1/250th of a second up to about 1/8000th of a second, though most have a shutter speed of about 1/4000th of a second. In some implementations, one or more fast shutter speed cameras 660 are mountable on a telescoping pole 654 on the body of the UAV 110. In some implementations, systems consistent with the present disclosure comprise on-board fast shutter speed cameras 660 mounted on poles 654 to monitor fast anomalous events that can occur on the UAV 110. In some variations, these events include but are not limited to the sudden snapping of propeller tips and unusual bending of UAV components or the UAV body. In one or more variants, one camera 660, multiple cameras 660, a 360-degree camera 660, or a combination thereof can be utilized. In multiple variations, the placement of the cameras 660 can be strategically selected based on specific monitoring needs.

In further configurations, the thermal cameras 660 provide continuous imaging of the UAV 110's arms, motors, and propellers, detecting structural anomalies or rapid events that could lead to potential in-flight faults or damage to the UAV. In some implementations, the fast shutter speed cameras 660 are designed to capture rapid movements and structural changes in real-time, ensuring immediate detection and response. In some variations, the data collected from these cameras 660 can be analyzed by on-board processors such as processor 174 in MCU 170 to identify and classify the detected anomalies or faults. In one or more variants, the integration of these thermal cameras 650 and fast shutter speed cameras 660 enhances the overall fault detection system by providing a comprehensive view of both thermal and mechanical abnormalities. In multiple variations, the use of fast shutter speed cameras 660 is particularly beneficial in high-stakes environments where rapid fault detection is critical. In further configurations, these cameras work in conjunction with other sensors to provide a multi-faceted approach to UAV health monitoring.

In some implementations, a control and communication module 180 is within the microcontroller. In some implementations, the control and communication module 180 is communicatively connected to receive signals from one or more of the plurality of microphones 120, the array of vibration sensors 130, the integrated pressure sensors 140, the one or more thermal cameras 150, and the one or more fast shutter speed cameras 160. In some implementations, the control and communication module 180 is configured to provide real-time alerts 194 and facilitate automatic mission abort in response to detected faults through analysis of one or more of the received signals.

In some implementations, the control and communication module 180 is integrated with the UAV's flight control system 104, enabling the control and communication module 180 to send real-time control signals based on the analysis of data from various on-board sensors. In some implementations, the control and communication module 180 receives input from the MCU 170 which has processed data from the plurality of microphones 120, the array of vibration sensors 130, the integrated pressure sensors 140, the thermal cameras 150, and the fast shutter speed cameras 160. However, it will be understood that the control and communication module 180 can be integrated into the MCU 170 in various implementations. This control and communication module 180 processes the incoming data using machine learning algorithms executed on the microcontroller unit (MCU) 170, which includes a processor 174 and memory 178. Upon detecting any anomaly indicative of potential faults, the control and communication module 180 is configured to generate control signals that can be transmitted to the UAV's flight control system 104. These control signals can prompt immediate actions such as adjusting the flight path, modifying propulsion power, or initiating an automatic mission abort to ensure the UAV 110's safety and operational integrity.

In some implementations, the control and communication module 180 is further configured to automatically execute real-time corrective measures in response to fault detections. Such automated responses can include adjustments to the UAV's throttle, pitch, roll, and yaw parameters to stabilize the aircraft and mitigate the detected fault's effects. Specifically, upon detecting excessive vibration or abnormal acoustic signals that may indicate an imminent propeller failure, for example, the control and communication module 180 electronically communicates with the UAV's flight control system 104 to dynamically reduce power to the affected motor, adjust the remaining motors to compensate for the change in thrust. In additional implementations, this set of corrective measures can lead to the combination of the control and communication module 180 and the UAV's flight control system 104 to command the UAV to execute an emergency landing protocol. In various implementations, this response mechanism leverages the machine learning models to predict fault progression and implements a tiered response strategy, escalating from minor corrective adjustments to full mission aborts depending on the severity of the detected fault. In further variations, the control and communication module 180 is configured to respond to the indication of any fault detections by altering operating parameters of the UAV to reduce or eliminate the indication of the detected fault.

In one or more implementations, in addition to active fault mitigation, the control and communication module 180 incorporates a predictive maintenance feature that uses historical fault detection data to schedule maintenance tasks proactively. By analyzing patterns in the data collected by the onboard sensors and processed through the machine learning models, systems and methods consistent with the present disclosure can identify components with a high likelihood of failure and alert maintenance crews, through transmitting alert signals such as alert 184. Such alerts catalyze inspection and replacement of these components during servicing.

The integration of the control and communication module 180 with the MCU 170 and the diverse array of sensors enhances the UAV's autonomous fault detection and response capabilities. The MCU 170, in conjunction with the control and communication module 180, continuously monitors the data streams from the sound sensors (microphones 120), which capture acoustic signals that can in some cases indicate mechanical issues; the vibration sensors 130, which detect abnormal vibration patterns; the pressure sensors 140, which monitor structural stress and deformation; the thermal cameras 150, which provide thermal imaging to detect overheating and structural abnormalities; and the fast shutter speed cameras 160, which capture rapid structural changes and potential mechanical failures. The MCU 170 processes this multi-sensor data in real-time, employing machine learning models such as convolutional neural networks (CNNs) and recurrent neural networks (RNNs) to classify and analyze the data. If a critical anomaly is detected, the control and communication module 180 generates alerts 194 and control signals, ensuring timely and coordinated responses to mitigate potential failures and enhance UAV operational reliability. In some implementations, methods consistent with the present disclosure further comprises relaying real-time alerts from a control and communication module to a UAV operator through a user interface.

In some variations, the MCU 170 and the different types of sensors (sound sensors 120, vibration sensors 130, pressure sensors 140, thermal cameras 150, and fast shutter speed cameras 160) are configured to leverage their on-board sensing capabilities to detect anomalies in nearby drones mid-flight. This configuration enables a UAV 110 equipped with the fault detection system disclosed herein to monitor other UAVs operating in close proximity, enhancing the situational awareness and safety of a fleet of drones. The sound sensors 120 can capture acoustic signals emanating from nearby UAVs, identifying distinct auditory anomalies such as unusual motor noises or mechanical defects. Vibration sensors 130 can detect vibrations transmitted through the air or ground, indicating potential issues in the structural integrity or operation of neighboring drones. Pressure sensors 140, while primarily focused on the host UAV 110, can also sense nearby changes in air pressure caused by the flight patterns or mechanical actions of other drones. Thermal cameras 150 can capture heat signatures of adjacent UAVs, identifying overheating components or thermal anomalies that could signify impending faults. Fast shutter speed cameras can record rapid movements or structural changes in nearby UAVs, such as sudden propeller damage or unusual bending of components. By integrating data from these sensors, the MCU 170 can process and analyze the collective information using machine learning algorithms to detect and classify potential anomalies in other drones, providing real-time alerts to operators.

Returning to FIG. 1, in one or more embodiments of a method consistent with the present disclosure, a first step comprises real-time fault detection in an unmanned aerial vehicle (UAV) 110 having a structure comprising at least a fuselage 118, propellers 114, and landing gear 116. The method further comprises capturing acoustic signals with a plurality of microphones 120 mounted on-board the UAV 110. In some implementations, a method consistent with the present disclosure further comprises detecting vibration abnormalities with embedded vibration sensors 130 mounted on-board the UAV 110. In some aspects, the method further comprises monitoring stress of the structure of the UAV with on-board thin-film pressure sensors 140. In alternate variations, the method further comprises imaging UAV components with thermal cameras 150 mounted on-board the UAV 110. In alternate variations, the method further comprises processing the captured signals and data collected through the steps above with an on-board microcontroller 170 communicatively connected to the microphones 120, vibration sensors 130, pressure sensors 140, and thermal cameras 150, the microcontroller 170 including a processor 174 with memory and code. In alternate variations, the microcontroller 170 is configured to run machine learning algorithms defined by the code. In alternate variations, the code configures the processor 174 of the microcontroller 170 to identify anomalies indicative of potential UAV 110 faults while in operation (e.g., flight).

It is to be understood that like or similar numerals in the drawings represent like or similar elements through the several figures, and that not all components or steps described and illustrated with reference to the figures are required for all embodiments or arrangements.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “contains”, “containing”, “includes”, “including,” “comprises”, and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof.

Terms of orientation are used herein merely for purposes of convention and referencing and are not to be construed as limiting. However, it is recognized these terms could be used with reference to an operator or user. Accordingly, no limitations are implied or to be inferred. In addition, the use of ordinal numbers (e.g., first, second, third) is for distinction and not counting. For example, the use of “third” does not imply there is a corresponding “first” or “second.” Also, the phraseology and terminology used herein is for the purpose of description and should not be regarded as limiting. While the disclosure has described several exemplary embodiments, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to embodiments of the disclosure without departing from the essential scope thereof. Therefore, it is intended that the invention not be limited to the particular embodiments disclosed, or to the best mode contemplated for carrying out this invention, but that the invention will include all embodiments falling within the scope of the appended claims.

The subject matter described above is provided by way of illustration only and should not be construed as limiting. Various modifications and changes can be made to the subject matter described herein without following the example embodiments and applications illustrated and described, and without departing from the true spirit and scope of the invention encompassed by the present disclosure, which is defined by the set of recitations in the following claims and by structures and functions or steps which are equivalent to these recitations.

1. A fault detection system for an unmanned aerial vehicle (UAV), comprising:
a UAV on-board microcontroller having a processor with a memory,
wherein the processor is communicatively connected to the UAV,
wherein code is storable in the memory and executable in the processor,
wherein the microcontroller is configured to run one or more machine learning models defined by the code, and
wherein the microcontroller is configured to alter operating parameters of the UAV;
a plurality of microphones mounted on a UAV,
wherein the microphones are configured to capture acoustic signals characteristic of UAV operation conditions;
an array of vibration sensors embedded within the UAV,
wherein the vibration sensors are configured to detect vibration patterns and store them as readable data in the memory, and
wherein the code further configures the processor to analyze the vibration patterns for abnormalities relative to parameters stored in the memory indicative of a first fault detection;
pressure sensors integrated into the structure of the UAV,
wherein the pressure sensors are configured to monitor for UAV structural stress and deformation indicative of a second fault detection;
one or more thermal cameras mounted on the UAV,
wherein the thermal cameras are configured to capture images indicating overheating and structural abnormalities indicative of a third fault detection;
a control and communication module within the microcontroller,
wherein the control and communication module is communicatively connected to receive signals from the plurality of microphones, the array of vibration sensors, the integrated pressure sensors, and the one or more thermal cameras, and
wherein the control and communication module is configured to store state information responsive to the indication of the first, second, or third fault detections, if any, and
wherein the control and communication module is further configured to respond to the indication of any fault detections by altering operating parameters of the UAV to reduce or eliminate the indication of the detected fault.

2. The system of claim 1, wherein the control and communication module is further configured to provide real-time alerts in response to indications of the first, second, or third fault detections, if any, through analysis of one or more of the received signals.

3. The system of claim 1, wherein the microphones are configured to detect a range of acoustic anomalies comprising motor noises and mechanical defects.

4. The system of claim 1, wherein the vibration sensors are accelerometers.

5. The system of claim 1, wherein the UAV further comprises a fuselage supporting propellers and landing gear, and wherein the pressure sensors are thin-film pressure sensors configured to detect plastic deformation and are mounted in the vicinity of the propellers, the landing gear, or both the vicinity of the propellers and the landing gear.

6. The system of claim 1, wherein each thermal camera is configured to conduct continuous imaging of one or more UAV components.

7. The system of claim 1, wherein the microcontroller utilizes one or more TinyML algorithms.

8. The system of claim 1, wherein the control and communication module is integrated within a flight control system of the UAV and is configured to send mission abort signals to the flight control system upon detection of a fault.

9. The system of claim 1, further comprising one or more fast shutter speed cameras with a shutter speed falling in the range of about 1/250th of a second up to about 1/8000th of a second.

10. The system of claim 1, wherein data collected by the vibration sensors is analyzed by deep learning models run in the microcontroller and utilizing time-series analysis in order to identify gradual deformation.

11. The system of claim 1, wherein the control and communication module further comprises a user interface to provide one or more of visual and auditory alerts to the UAV operator upon fault detection.

12. A method for real-time fault detection in an unmanned aerial vehicle (UAV) having a structure comprising at least a fuselage, propellers, and landing gear, comprising:
capturing acoustic signals with a plurality of microphones mounted on-board the UAV;
detecting vibration abnormalities with embedded vibration sensors mounted on-board the UAV;
monitoring stress of the structure of the UAV with on-board thin-film pressure sensors;
imaging UAV components with thermal cameras mounted on-board the UAV; and
processing the captured signals and data collected through the steps above with an on-board microcontroller communicatively connected to the microphones, vibration sensors, pressure sensors, and thermal cameras, the microcontroller including a processor having a memory and code,
wherein the microcontroller is configured to run machine learning algorithms defined by the code, and
wherein the code configures the processor of the microcontroller to detect anomalies indicative of potential UAV faults.

13. The method of claim 12, further comprising the step of adjusting, in real-time, parameters of the UAV in response to detected anomalies to update a mission.

14. The method of claim 12, further comprising the step of relaying real-time alerts from a control and communication module to a UAV operator through a user interface.

15. The method of claim 12, wherein the step of capturing acoustic signals further comprises the step of differentiating between different types of audio frequencies characteristic of various mechanical defects.

16. The method of claim 12, further comprising the step of processing signals from the vibration sensors.

17. The method of claim 12, wherein the step of monitoring structural stress further comprises real-time analysis of stress distribution and detection of plastic deformation in the structure of the UAV.

18. The method of claim 12, wherein the step of imaging further comprises generating one or more heatmaps and analyzing thermal patterns over time.

19. The method of claim 12, further comprising the step of using a fast shutter speed camera with a shutter speed falling in the range of about 1/250th of a second up to about 1/8000th of a second.

20. The method of claim 12, wherein the step of processing signals with on-board machine learning algorithms comprises employing convolutional neural networks, recurrent neural networks, or a combination thereof.

21. The method of claim 12, further comprising the step of training the machine learning algorithms on a dataset containing labeled examples of both normal and abnormal operational conditions for various UAV models.
